(19) United States
(12) Patent Application Publication
(10) Pub. No.: US 2003/0088334 A1
(43) Pub. Date: May 8, 2003

(54) Automatic tape loader robotics control interface system

(75) Inventors: Kirk M. Enochs, Boulder, CO (US); Barbara Lawson, Westminister, CO (US); Philip McClelland, Longmont, CO (US); Michael E. Moy, Lafayette, CO (US); Timothy P. Vander Veen, Longmont, CO (US); Glenn Klein, Mission Viejo, CA (US); Friedhelm Steinhilber, Rottweil (DE); Lew Frauenfelder, Boulder, CO (US); John Herron, Lyons, CO (US)

Correspondence Address: FOLEY & LARDNER, 402 WEST BROADWAY, 23RD FLOOR, SAN DIEGO, CA, 92101

(73) Assignee: BDT Products, Inc.

(21) Appl. No.: 10/005,362

(22) Filed: Nov. 8, 2001

(51) Int. Cl. G06F 19/00

(52) U.S. Cl. 700/245

(57) ABSTRACT

An automatic tape loader system for a media storage drive, such as a digital linear tape drive, comprises a robotics portion adapted interact with an interface drive, such as a Small Computer System Interface (SCSI) drive. An integrated controller is provided to integrate the mechanical operations of various components of the media storage device and the drive operations of the media storage device. A robotics module of the integrated controller is adapted to communicate with various mechanisms of the media storage device and various sensors associated with these mechanisms to control various mechanical operations of the media storage device. External devices such as an operator control panel (OCP) and a bar code reader may also be connected to the integrated controller to exchange information or commands between various components of the media storage device.

### BACKGROUND OF THE INVENTION

1. Field of the Invention

The present invention relates to magnetic tape drive systems, and more particularly, to tape loader control systems.

2. Background

Tape drives have been widely employed in industry for many years due to their ability to store large amounts of data on a relatively small, inexpensive and removable medium. The data are stored on tape drives utilizing a variety of designs, but in most cases, a magnetic tape medium is wound between a pair of tape reels as data are transferred to or from the tape medium. A typical example of a standard tape medium employed in many applications is one half-inch wide tape medium housed in a tape cartridge measuring at or near one inch in height.

Presently, conventional tape drives that utilize half-inch tape media are constructed in a full-height 5¼ (5.25) inch or larger form factor as defined by EIA Specification No. 3877-A, “Small Form Factor 133.35 mm (5.25) Disk Drives.” A typical example of a full-height 5¼ inch form factor for tape drives has a width dimension “W” of about 5.75 inches, a depth dimension “D” of about 8.1 inches and a height dimension “H” of about 3.2 inches. Therefore, conventional half-inch tape drives typically occupy two drive bays when installed in a conventional computer housing.

Automatic tape loader devices have also been employed successfully for many years in various computer systems. Such automatic tape loader devices have been employed with cassette tape loading devices which position the cassettes in an upright position for entering the tape drive. Currently, such automatic tape loader units are designed to be mounted in conventional racks and have a height of approximately 8 inches. Such a device can fit into a standard-size space in a conventional rack, which has component mounting spaces in even multiples of one unit of space, referred to as “1U”, which is equal to approximately 1.76 inches. The 8-inch automatic tape loader unit can be mounted into a rack space of “5U”, or approximately 8.8 inches. It is highly desirable to reduce the overall height of the automatic tape loader units to render them as compact as possible. In addition, it is desirable to greatly reduce the cost of the automatic tape loader devices.

Furthermore, a conventional automatic tape loader unit typically requires a drive controller for controlling the drive operations of digital cassette tapes and a separate robotics controller for controlling the loading and unloading of digital cassette tapes into and out of the drive port of the digital linear tape drive unit, as well as other mechanical functions. Separate software algorithms are provided for the drive controller and the robotics controller in a conventional automatic tape loader unit with separate controller units. The requirement of separate controllers and separate software algorithms results in substantial costs and space requirements.

It is desirable to reduce the size and cost of automatic tape loader units.

### BRIEF DESCRIPTION OF THE DRAWINGS

The present invention will be described with respect to particular embodiments thereof, and references will be made to the drawings in which:

FIG. 1 shows a block diagram of an automatic tape loader system with an integrated drive and robotics controller in an embodiment according to the present invention;

FIG. 2 shows a diagram of an automatic tape loader drive and controller interface system in an embodiment according to the present invention, illustrating the control of various electronic and mechanical elements in an integrated automatic tape loader unit;

FIG. 3 illustrates a partial cut-away of an automatic loader library according to an embodiment of the invention;

FIG. 4 illustrates the movement of a cartridge pursuant to an ejection process according to an embodiment of the invention; and

FIGS. 5A and 5B illustrate the movement of a cartridge pursuant to an insertion process according to an embodiment of the invention.

### DETAILED DESCRIPTION

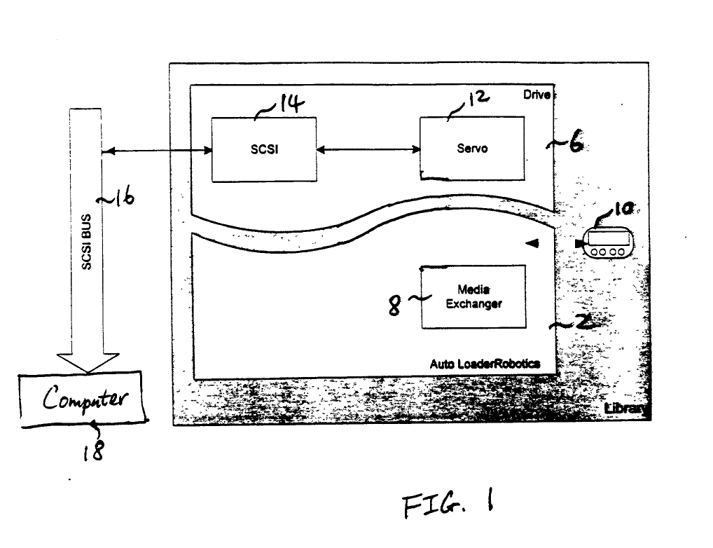

FIG. 1 shows a block diagram of an automatic tape loader system with a loader robotics adapted to interact with a Small Computer System Interface (SCSI) tape drive in an embodiment according to the present invention. The system comprises an automatic loader robotics 2 in close proximity to a SCSI drive 6. The automatic loader robotics 2 comprises a media exchanger 8 which interacts with mechanisms of the SCSI drive 6, which may be a digital linear tape drive. The SCSI drive 6 comprises a drive servo module 12 connected to SCSI controller 14, which is in turn connected to a SCSI bus 16 to communicate with a computer system 18. The automatic tape loader system which comprises the automatic loader robotics 2 and the SCSI drive 6 may be regarded as a data storage library for the computer system 18.

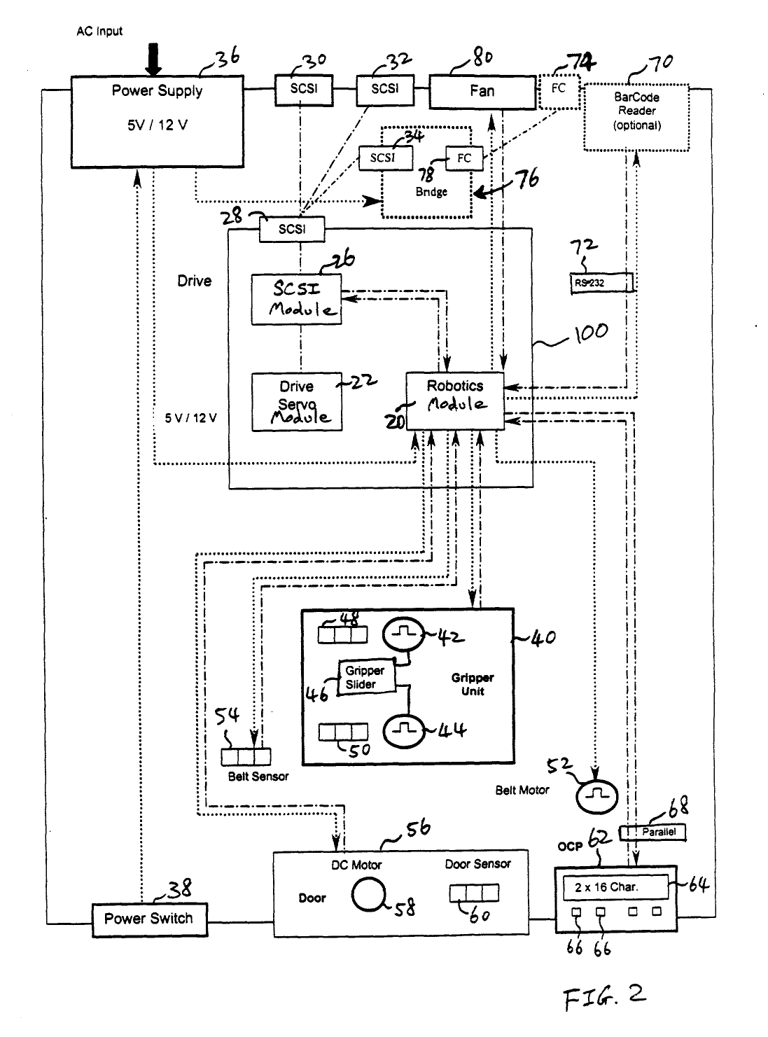

FIG. 2 shows a diagram of a detailed embodiment of an automatic tape loader system according to the present invention, with an integrated controller 100 having a robotics module 20, a drive servo module 22, and a SCSI module 26. The integrated controller 100 may be implemented within the library, for example, on the drive, in the robotics, or as a separate component. The automatic tape loader system also comprises a plurality of SCSI interfaces 28, 30, 32 and 34.

A power supply 36, which in one embodiment comprises a direct current (DC) power supply capable of converting input alternating current (AC) power into a DC voltage of 5 volts and 12 volts, supplies electrical power to various components in the automatic tape loader system. A power switch 38 controls on and off operations of the DC power supply 36.

The robotics module 20 of the integrated controller 100 exchanges information with the SCSI module 26 in both directions with integrated control of the tape drive electronics and the robotics, which may include mechanisms for opening and closing a tape drive door, a gripper unit for gripping a cassette tape, a conveyor belt for moving cassette tapes to different positions, and other mechanical components. The SCSI drive servo module 22 is connected to the SCSI module 26, which is in turn connected to a SCSI interface 28 to interface with additional SCSIs 30, 32 and 34. The SCSI is an industry-standard interface that is well known to a person skilled in the art for interfacing peripheral storage devices, such as hard disk drives and tape drives, with a central processing unit (CPU) in a computer system.

The automatic tape loader system according to embodiments of the present invention can be used for various types of digital linear tape drives, for example, a half-inch tape drive described in U.S. patent application Ser. No. 09/575,977, “Half-Inch Tape Drive in Half High Form Factor”, filed May 23, 2000, incorporated herein by reference.

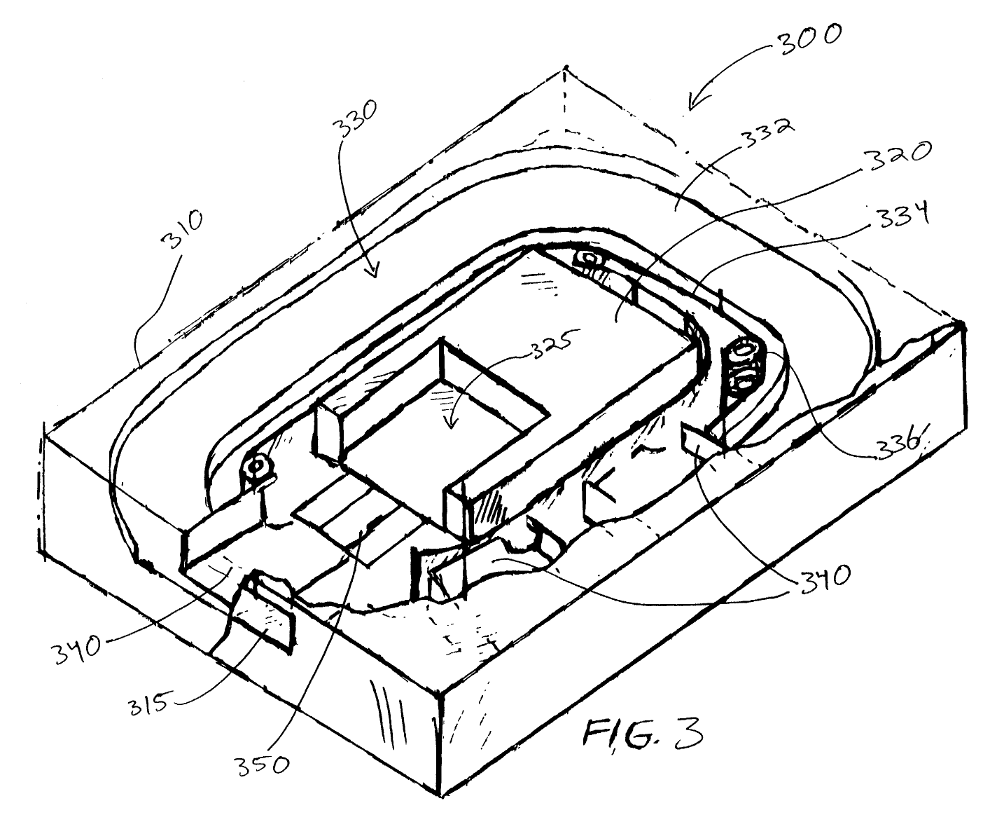

An embodiment of the invention may be implemented on a tape library illustrated in FIG. 3. FIG. 3 illustrates an automatic library 300 having a housing 310. The housing 310 is provided with a tape slot 315 through which cartridges may be exchanged between the outside and the automatic library 300. The automatic library 300 also comprises a drive 320 with a cartridge pocket 325. The cartridge pocket 325 is adapted to receive a cartridge therein, and the drive is adapted to read from or write to the cartridge in the cartridge pocket 325.

The automatic library 300 comprises a magazine 330 adapted to hold a plurality of cartridges. The magazine 330 comprises a track 332 and a drive belt 334. The drive belt 334 is driven by a motor (not shown) and is driven around sets of drive wheels 336. A plurality of carriers 340 is driven around the track 332 by the drive belt 334. Each carrier 340 is adapted to hold therein at least one cartridge. Thus, the carriers 340 may be used to store a plurality of cartridges within the library 300. Each carrier 340 may be positioned so as to receive a cartridge through the tape slot 315 and to exchange cartridges with the cartridge pocket 325 of the drive 320. A gripper system 350 is provided to perform this exchange.

Referring again to FIG. 2, a gripper unit 40 is adapted to communicate with the robotics module 20 to control gripping operations of a cassette tape in a digital linear tape drive. The gripper unit 40 comprises a gripper slider 46 for sliding a cassette tape into or out of a drive port, in which the cassette tape is held when data are read from or written to the tape. The gripper slider 46 is actuated by at least one stepper motor, and the movement and/or position of the gripper slider is sensed by at least one gripper sensor which is positioned to sense the movement and/or position of the gripper slider in order to provide a feedback to the robotics module for indicating the position or movement of the gripper slider.

In the embodiment shown in FIG. 2, the gripper unit 40 includes two gripper motors 42 and 44 which are connected to the gripper slider 46 to move the gripper slider both along an insertion axis and along a gripping axis. The gripper unit 40 also includes two gripper sensors 48 and 50 for sensing the position and/or movement of the gripper slider 46, and providing feedback information including the sensed position or movement of the gripper slider 46 to the robotics module 20 of the integrated controller 100. The integrated controller 100 supplies power to the gripper motors 42 and 44 in the gripper unit 40 for gripping a cassette tape. In an embodiment, the gripper motors 42 and 44 comprise stepper motors which can be driven by DC power transferred from the integrated controller 100.

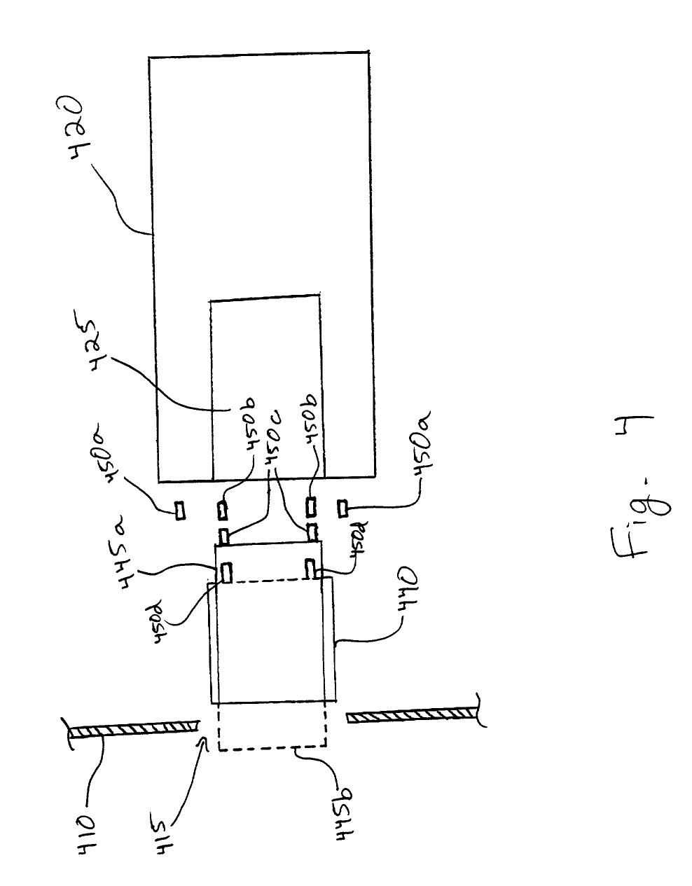

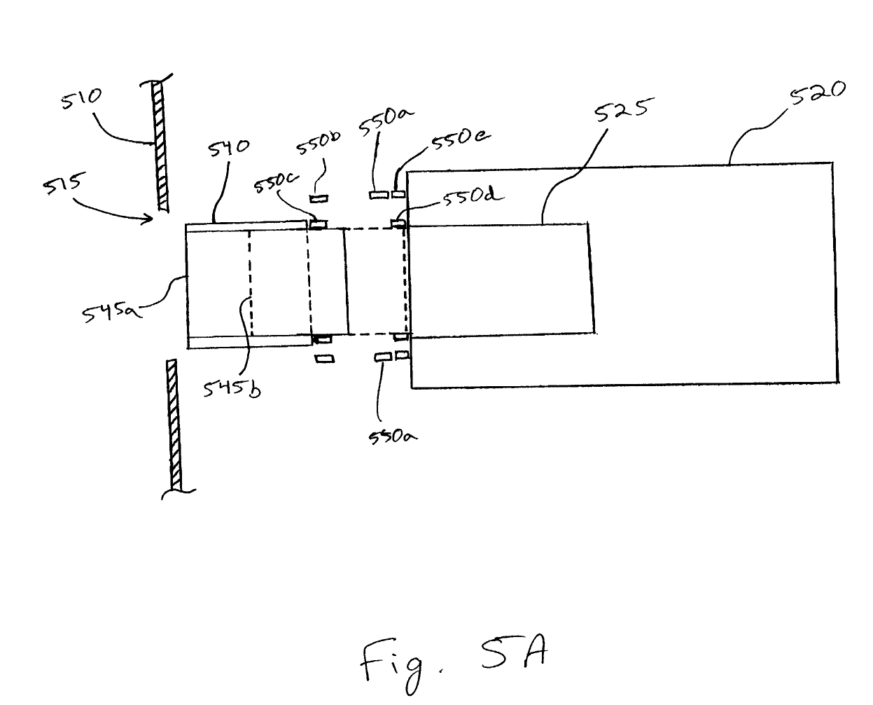

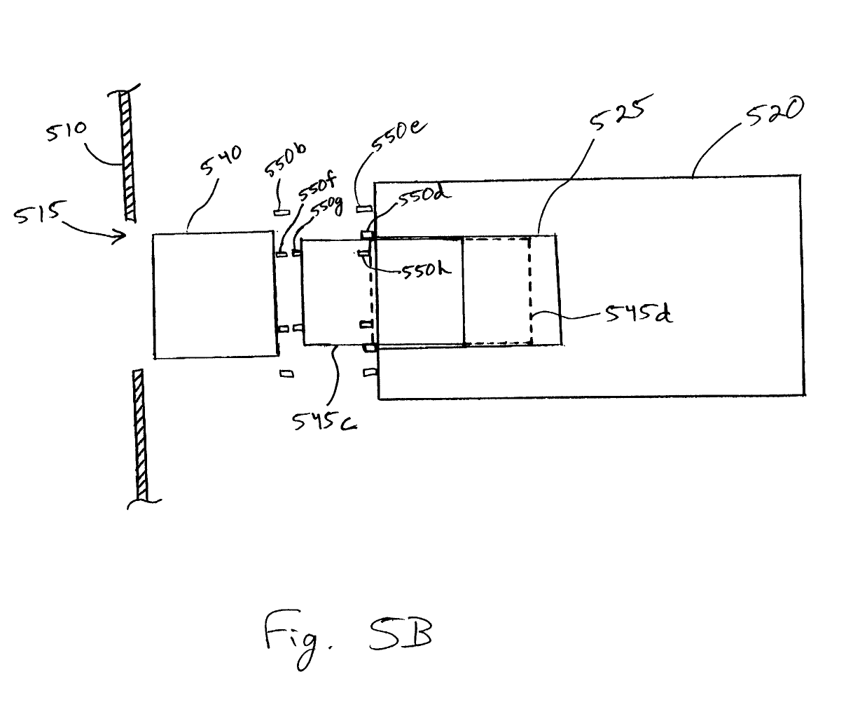

FIGS. 4, 5A and 5B illustrate the operation of the robotics portion of the library under control of the robotics module, for example, while performing certain functions. FIG. 4 illustrates the movements associated with a command to eject a cartridge from the library to an outside user. FIG. 4 illustrates a tape library with a housing 410 having a tape slot 415. Inside the housing 410, a tape drive 420 having a cartridge pocket 425 is provided. A carrier 440 with a cartridge 445 to be ejected is aligned with the tape slot 415. Initially, the cartridge is provided in a secured position on the carrier 440, as illustrated in FIG. 4 by reference numeral 445a. A gripper system having two opposing fingers 450 is provided to maneuver the cartridge 445. The gripper fingers 450 are adapted to move together along an insertion axis (left-right in FIG. 4) and opposingly along a gripping axis (up-down in FIG. 4). Initially, the gripper fingers 450 are provided in a rest position as illustrated in FIG. 4 by reference numerals 450a.

Once the robotics module begins to execute the ejection command, the gripper fingers are moved to a position such that the distance between the two fingers 450b is less than the width of the cartridge 445. The robotics module then causes the fingers to move along the insertion axis to engage an end of the cartridge 445a, the fingers reaching the position labeled 450c in FIG. 4. The fingers 450 then force the cartridge until the fingers reach the position labeled 450d, at which point the cartridge is located at the position labeled 445b. In this position, an outside user is able to grasp and remove the cartridge 445 from the library.

The ejection procedure may be initiated when the integrated controller receives an ejection command over the SCSI interface, for example. The SCSI module of the integrated controller interprets the command and determines whether the command can be fulfilled. For example, the SCSI module may first check to determine whether the requested cartridge is in fact in the library. The SCSI module may then break down the ejection command into a more primitive command to be transmitted to the robotic module of the integrated controller. Once the robotic module has verified the command by, for example, checking an inventory table, the robotic module causes the specific carrier to be moved into alignment with the tape slot in the housing.

Alternatively, if the cartridge to be ejected is presently in the cartridge pocket of the drive, the carrier is moved into alignment with the cartridge pocket. In this instance, the robotic module may then inform the drive servo module that the carrier is in a position to receive the cartridge. The drive servo module may then eject the cartridge from the cartridge pocket of the drive. The robotic module may then cause the cartridge to be mounted onto the carrier, and the carrier may, if necessary, be moved into alignment with the tape slot.

FIGS. 5A and 5B illustrate the movements associated with a command to transfer a cartridge 545 from a carrier 540 to the cartridge pocket 525 of a drive 520. Initially, the cartridge 545 is provided in a secured position on the carrier 540, as illustrated in FIG. 5A by reference numeral 545a. A gripper system having two opposing fingers 550 is provided to maneuver the cartridge 545. Initially, the gripper fingers 450 are provided in a rest position as illustrated in FIG. 5A by reference numerals 550a.

Once the robotics module begins to execute the insertion command, the gripper fingers are moved along the insertion axis to a position such that the two fingers 550b are on opposite sides of the cartridge 545. The robotics module then causes the fingers to move along the gripping axis to engage the sides of the cartridge 545a near a front end of the cartridge 545a, the fingers reaching the position labeled 550c in FIG. 5A. The fingers 550 then move the cartridge 545 toward the cartridge pocket 525 until the fingers reach the position labeled 550d, at which point the cartridge is located at the position labeled 545b. The fingers 550 then disengage the cartridge 545 and move apart to the position labeled 550e. The fingers 550 are then moved along the insertion axis back to position 550b and then along the gripping axis to position 550c to re-engage the sides of the cartridge 545 at a central region of the cartridge 545. The cartridge 545 is then moved further toward the cartridge pocket 525 by moving the fingers along the insertion axis until the fingers reach the position labeled 550d. At this point, the cartridge 545 is located at the position labeled 545c in FIG. 5B.

Referring now to FIG. 5B, the fingers 550 again disengage and move along the gripping axis to position 550e and then along the insertion axis to position 550b. The fingers 550 are now moved to a position such that the distance between the two fingers 550 is less than the width of the cartridge 545, as indicated by position 550f. The robotics module then causes the fingers to move along the insertion axis to engage an end of the cartridge 545c, the fingers reaching the position labeled 550g in FIG. 5B. The fingers 550 then force the cartridge 545 until the fingers reach the position labeled 550h, at which point the cartridge is located at the position labeled 545d. In this position, the cartridge is completely inserted into the cartridge pocket 525, and the drive 520 is able to access the tape for reading or writing.

The cartridge insertion procedure may be initiated when the integrated controller receives a SCSI command over the SCSI interface, for example. This may occur when, for example, a software application on a computer requires reading from or writing to a particular cartridge in the library. The command is received by the SCSI module of the integrated controller. The SCSI module may determine whether the command can be fulfilled. The SCSI module interprets the command and may convert the command to a more primitive command to be relayed to the robotics module, which may first determine whether the command can be fulfilled. The robotics module then causes the specific carrier to be moved into alignment with the cartridge pocket of the drive and causes the gripper system to insert the cartridge into the cartridge pocket. A photo-optical sensor may be activated by the complete insertion of the cartridge into the cartridge pocket, causing a signal to be sent to the drive servo module indicating the presence of a cartridge.

Referring again to FIG. 2, the robotics module 20 of the integrated controller 100 is also connected to a belt motor 52 and a belt sensor 54 for controlling the movement of a belt drive of the magazine, for example, for transporting a tape cassette to or from a position which allows the gripper unit to grip the cassette and transport the cassette to a drive port, in which the cassette is held when data are read from or written to the tape. The belt sensor 54 provides feedback information to the robotics module 20 indicating the movement of the belt drive by the belt motor 52. The integrated controller 100 provides power to the belt motor 52, which in an embodiment comprises a stepper motor, to activate the belt drive.

Furthermore, the robotics module 20 of the integrated controller 100 is also capable of controlling a door mechanism 56 which includes a door motor 58 and a door sensor 60. In an embodiment, the door motor 58 comprises a DC motor which can be driven by DC power transferred from the integrated controller 100. The door sensor 60 is capable of sensing the position of the door for loading or unloading a cassette tape, or indicating whether the door is open or closed. The information obtained by the door sensor 60 is fed back to the robotics module 20 of the integrated controller 100, which in turn controls the door motor 58, or provides an indication to a user that the door is open, closed, or partially open.

In another embodiment, the robotics module 20 is also connected to an operator control panel (OCP) 62, which has a display panel 64 for displaying selected information to a user, as well as one or more buttons 66 to allow the user to manually control at least some of the operations of the automatic tape loader device. For example, the display panel 64 may be a light emitting diode (LED) or liquid crystal display (LCD) panel which displays sensor information received by the robotics module 20 from various sensors, such as gripper sensors 48 and 50, the belt sensor 54, or the door sensor 60 in the system. One of the buttons 66 on the OCP 62 may be used for manually controlling the opening or closing of the cassette tape door through the robotics module 20 of the integrated controller 100. In an embodiment, the OCP 62 communicates with the robotics module 20 through a parallel interface 68.

In another embodiment, the robotics module 20 is adapted to communicate with a bar code reader 70 to allow the digital linear tape drive to retrieve information read by the bar code reader 70. In this embodiment, the information read by the bar code reader 70 may be provided directly to the computer system through one of the SCSIs. In an embodiment, the bar code reader 70 is connected to the integrated controller 100 through a serial interface 72, such as an RS-232 interface. Furthermore, the integrated controller 100 may also supply DC power to the bar code reader 70.

In another embodiment, a bridge device 76 may optionally be provided to allow the connection of the automatic tape loader device to interfaces other than SCSI. In the embodiment shown in FIG. 2 a small computer system interface-fiber channel (SCSI-FC) bridge 76 is connected between a Fiber Channel (FC) 74 and the integrated controller 100. In an embodiment, the SCSI-FC bridge 76 provides an additional FC 78 which allows the connection of the automatic tape loader to an industry standard Fiber Channel interface.

In the embodiment shown in FIG. 2, the SCSI module 26 of the integrated controller 100 controls the additional SCSIs 30, 32 and 34 through the SCSI 28. Additional data input or output devices may be connected to the SCSIs, such as SCSIs 30 and 32 in the automatic tape loader system shown in FIG. 2, to allow direct data transfers to be achieved between the cassette tape in the drive port of the digital linear tape drive and the data input or output devices connected to the SCSIs. In an embodiment, the power supply 36 also supplies DC power directly to the SCSI-FC bridge.

In a further embodiment, the integrated controller 100 may be connected to additional mechanical components, such as a fan 80 for cooling the digital linear tape drive. In an embodiment, the operation of the fan 80 may be dynamically controlled by the robotics module 20 in dependence upon the ambient temperature of the digital linear tape drive or the computer. For example, DC power may be supplied by the integrated controller 100 to the fan 80 if a temperature sensor indicates to the robotics module 20 that the fan 80 needs to be activated to reduce the temperature of the digital linear tape drive. Other mechanical components for the digital linear tape drive may also be controlled by the robotics module 20 in a similar manner.

In one embodiment, the integrated controller may conduct an inventory procedure at various times such as, for example, at power up. The integrated loader may cause the robotics module to conduct a survey of each carrier in the magazine to detect the presence or absence of a cartridge. The integrated controller may also cause the detection of a cartridge in the cartridge pocket of the drive. The robotics module may utilize the bar code reader to specifically identify each cartridge present in the library. The integrated controller may then build an inventory table. The inventory table may be updated each time a cartridge is moved either between the library and the outside or between a carrier and the cartridge pocket of the drive. The inventory table may be stored in the robotics module, the drive servo module, the SCSI module and/or in a separate storage area.

The present invention has been described with respect to particular embodiments thereof, and numerous modifications can be made which are within the scope of the invention as set forth in the claims.

What is claimed is:

1. An automatic tape loader system including a tape drive and an automatic loader robotics, comprising:
a single small computer system interface (SCSI) drive for controlling both the tape drive and the automatic loader robotics, comprising:
a drive servo; and
a SCSI module adapted to communicate with the drive servo, the SCSI module being capable of receiving SCSI commands;
an interface connected to the SCSI drive; and
an automatic loader robotics module adapted to communicate with the interface, the automatic loader robotics module comprising a media exchanger.

2. The system of claim 1, wherein the interface comprises a serial interface.

3. The system of claim 2, wherein the serial interface comprises an RS-232 interface.

4. The system of claim 1, wherein the automatic loader robotics includes a gripper unit comprising:
a gripper slider;
at least one stepper motor connected to the gripper slider; and
at least one gripper sensor positioned to sense movement of the gripper slider.

5. The system of claim 1, further comprising:
a belt motor connected to the automatic loader robotics module; and
a belt sensor connected to the automatic loader robotics module.

6. The system of claim 5, wherein the belt motor comprises a stepper motor.

7. The system of claim 1, further comprising:
a door motor connected to the automatic loader robotics module; and
a door sensor connected to the automatic loader robotics module.

8. The system of claim 7, wherein the door motor comprises a direct current (DC) motor.

9. The system of claim 1, further comprising a bar code reader connected to the automatic loader robotics module.

10. The system of claim 1, further comprising:
a fiber channel (FC) interface; and
a small computer system interface-fiber channel (SCSI-FC) bridge connected between the SCSI drive and the FC interface.

11. The system of claim 1, further comprising an operator control panel (OCP) connected to the automatic loader robotics module.

12. The system of claim 11, further comprising a parallel interface connected between the automatic loader robotics module and the OCP.

13. The system of claim 1, further comprising a power supply connected to the automatic loader robotics module.

14. The system of claim 13, further comprising a power switch connected to the power supply.

15. The system of claim 1, further comprising a SCSI bus connected to the SCSI drive to transfer the SCSI commands to the SCSI drive.

16. The system of claim 1, further comprising a fan connected to the automatic loader robotics module.

17. An automatic tape loader system, comprising:
a robotics module;
a small computer system interface (SCSI) module adapted to communicate with the robotics module;
at least one SCSI interface connected to the SCSI module;
a drive servo module connected to the SCSI module;
a gripper unit adapted to communicate with the robotics module, the gripper unit comprising:
a gripper slider;
at least one gripper motor connected to the gripper slider; and
at least one gripper sensor positioned to sense movement or position of the gripper slider;
a belt motor adapted to communicate with the robotics module;
a belt sensor adapted to communicate with the robotics module;
a door motor adapted to communicate with the robotics module; and
a door sensor adapted to communicate with the robotics module.

18. The system of claim 17, further comprising a bar code reader adapted to communicate with the robotics module.

19. The system of claim 18, further comprising a serial interface connected between the bar code reader and the robotics module.

20. The system of claim 19, wherein the serial interface comprises an RS-232 interface.

21. The system of claim 17, further comprising:
a fiber channel (FC) interface; and
a small computer system interface-fiber channel (SCSI-FC) bridge connected between said at least one SCSI interface and the FC interface.

22. The system of claim 17, further comprising an operator control panel (OCP) adapted to communicate with the robotics module.

23. The system of claim 22, further comprising a parallel interface connected between the robotics module and the OCP.

24. The system of claim 17, further comprising a power supply connected to the robotics module.

25. The system of claim 24, further comprising a power switch connected to the power supply.

26. The system of claim 17, wherein the belt motor comprises a stepper motor.

27. The system of claim 17, wherein said at least one gripper motor comprises at least one stepper motor.

28. The system of claim 17, wherein the door motor comprises a direct current (DC) motor.

29. The system of claim 17, further comprising a fan connected to the robotics module.

30. An automatic tape loader system, comprising:
a robotics module;
a small computer system interface (SCSI) module adapted to communicate with the robotics module;
at least one SCSI interface connected to the SCSI module;
a drive servo module connected to the SCSI module;
a gripper unit connected to the robotics module, the gripper unit comprising:
a gripper slider;
at least one gripper motor connected to the gripper slider; and
at least one gripper sensor positioned to sense movement of the gripper slider;
a belt motor connected to the robotics module;
a belt sensor connected to the robotics module;
a bar code reader connected to the robotics module;
a fiber channel (FC) interface;
a small computer system interface-fiber channel (SCSI-FC) bridge connected between said at least one SCSI interface and the FC interface;
a door motor connected to the robotics module; and
a door sensor connected to the robotics module.

31. The system of claim 30, further comprising a serial interface connected between the bar code reader and the robotics module.

32. The system of claim 31, wherein the serial interface comprises an RS-232 interface.

33. The system of claim 30, further comprising an operator control panel (OCP) connected to the robotics module.

34. The system of claim 33, further comprising a parallel interface connected between the robotics module and the OCP.

35. The system of claim 30, further comprising a power supply connected to the robotics module and the SCSI-FC bridge.

36. The system of claim 35, further comprising a power switch connected to the power supply.

37. The system of claim 30, wherein the belt motor comprises a stepper motor.

38. The system of claim 30, wherein said at least one gripper motor comprises at least one stepper motor.

39. The system of claim 30, wherein the door motor comprises a direct current (DC) motor.

40. The system of claim 30, further comprising a fan connected to the robotics module.
